(19) United States
(12) Patent Application Publication
(10) Pub. No.: US 2025/0284719 A1
(43) Pub. Date: Sep. 11, 2025

(54) MACHINE COGNITION WORKFLOW ENGINE WITH REWINDING MECHANISM

(71) Applicant: Microsoft Technology Licensing, LLC, Redmond, WA (US)

(72) Inventors: John MAEDA, Redmond, WA (US); Umesh MADAN, Bellevue, WA (US); Benjamin Livesley THOMAS, Woodinville, WA (US)

(73) Assignee: Microsoft Technology Licensing, LLC, Redmond, WA (US)

(21) Appl. No.: 18/601,901

(22) Filed: Mar. 11, 2024

(51) Int. Cl. G06F 16/33; G06F 16/332; G06F 40/279

(52) U.S. Cl. CPC G06F 16/3334; G06F 16/3329; G06F 40/279

(57) ABSTRACT

A machine cognition workflow engine is provided in a computing system. The workflow engine receives a prompt, generates and executes a workflow instance based on the context of the prompt, and executes a first component to generate a first context. The workflow engine then executes a second component to generate a second context. Next, the second context is verified to generate a verification response. Responsive to determining that the verification response is below the predetermined threshold, the first component is executed again to regenerate the first context and the second context. Responsive to determining that the verification response is above the predetermined threshold, a remainder of the components is executed to generate and output a response for the prompt.

### BACKGROUND

Generative machine learning models such as large language models (LLMs) have been developed and paired with chatbot interfaces that enable users to query the LLM in a turn-based chat session. During training, most modern LLMs are trained on large datasets of tokenized text, as well as human generated responses to queries, using a next word prediction algorithm. During inference, in response to a query the LLM can generate a natural language response that mimics a human response to the query. Despite these advances, achieving efficient and accurate LLM output in response to complex user queries remains a technical challenge, as discussed below.

### SUMMARY

A computing system is provided, comprising a machine cognition workflow engine with a rewinding mechanism. The workflow engine is configured to receive a prompt, extract a message and a context of the prompt, generate a workflow instance based on the context, execute the generated workflow instance comprising a plurality of components, and execute a first set of components of the plurality of components, including a first component, to generate a first context. Based on the first context, the workflow engine then executes a second component following the first set of components to generate a second context. Next, the workflow performs verification of the second context to generate a verification response, and determines whether the verification response is below a first predetermined threshold. Responsive to determining that the verification response is below the first predetermined threshold, the workflow engine executes the first set of components again to regenerate the first context and the second context. Responsive to determining that the verification response is above the first predetermined threshold, the workflow engine executes a remainder of the plurality of components of the generated workflow instance based on the second context to generate a response for the prompt, and outputs the generated response for the prompt.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view showing a computing system according to a first example implementation, which uses a machine cognition workflow engine to generate a response to a prompt.

FIG. 2 is a schematic view showing a detailed depiction of the interactions between workflow instance and the verification module according to the first example implementation of FIG. 1.

FIG. 3 is a detailed schematic view of the computing system of FIG. 1, further showing, in detail, the components of the workflow instance executed by the machine cognition workflow engine.

FIG. 4 is another detailed schematic view of the computing system of FIG. 1, further showing the components of the workflow instance executed by the machine cognition workflow engine.

FIG. 5 shows a flowchart for a first method for managing workflows according to one example implementation.

FIG. 6 shows a flowchart for a second method for managing workflows according to one example implementation.

FIG. 7 shows a schematic view of an example computing environment in which the computing system of FIGS. 1-4 may be enacted.

### DETAILED DESCRIPTION

One drawback with generative models, and particularly LLMs, is that they are challenged when responding to complex or multi-part queries. Sometimes an LLM will output an inaccurate answer as if it was correct. Other times, the LLM will only answer part of the query. In yet other examples, the LLM will respond erroneously to one part of a multi-part query, and the error will cascade into other parts of the response. In yet other examples, the LLM will give up and inform the user that it cannot answer the query.

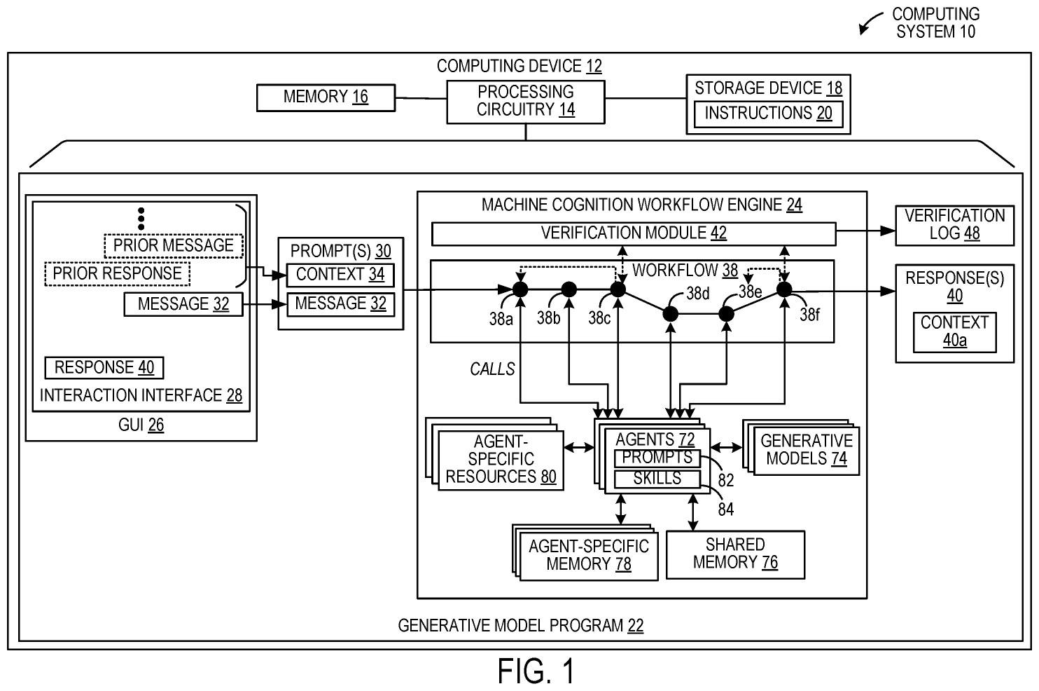

To address the issues described above, FIG. 1 illustrates a schematic view of a computing system 10 for managing workflows, according to a first example implementation. The computing system 10 includes a computing device 12 having processing circuitry 14, memory 16, and a storage device 18 storing instructions 20. In this first example implementation, the computing system 10 takes the form of a single computing device 12 storing instructions 20 in the storage device 18, including a generative model program 22 that is executable by the processing circuitry 14 to perform various functions including executing a machine cognition workflow engine 24 to cause an interaction interface 28 to be presented, receive, via the interaction interface 28, one or a plurality of prompts 30 from the user, and extract a message 32 and a context 34 of the one or the plurality of prompts 30.

In some instances, the interaction interface 28 may be a portion of a graphical user interface (GUI) 26 for accepting user input and presenting information to a user. In other instances, the interaction interface 28 may be presented in non-visual formats such as an audio interface for receiving and/or outputting audio, such as may be used with a digital assistant. In yet another example the interaction interface 28 may be implemented as an interaction interface application programming interface (API). In such a configuration, the input to the interaction interface 28 may be made by an API call from a calling software program to the interaction interface API, and output may be returned in an API response from the interaction interface API to the calling software program. The API may be a local API or a remote API accessible via a computer network such as the Internet.

It will be understood that distributed processing strategies may be implemented to execute the software described herein, and the processing circuitry 14 therefore may include multiple processing devices, such as cores of a central processing unit, co-processors, graphics processing units, field programmable gate arrays (FPGA) accelerators, tensor processing units, etc., and these multiple processing devices may be positioned within one or more computing devices, and may be connected by an interconnect (when within the same device) or via a packet switched network links (when in multiple computing devices), for example.

For a given prompt 30, based on the context 34, the workflow engine 24 generates a workflow instance 38 that specifies an execution of one or more components 38a-f. Then, the workflow engine 24 executes the generated workflow instance 38 to execute the one or more components 38a-f to thereby generate a response 40 for the given prompt 30. The generated response 40 may be outputted to be displayed on the interaction interface 28.

The workflow instance 38 defines a sequence of components 38a-f that are to be executed by the workflow engine 24, starting with a trigger component 38a which marks the beginning of the sequence. Although six components 38a-f are depicted in FIG. 1, it will be appreciated that the number of executable components in the workflow instance 38 is not particularly limited, and may be fewer or greater than six components. As the workflow engine 24 executes the workflow instance 38, the context 34 of the prompt 30 is passed to each component 38a-f of the workflow instance 38, which may be read from or updated by each component 38a-f before being passed to the next component 38b-f in the workflow instance 38. A final context object 50 may be outputted in the response 40 when the workflow instance 38 is completed.

The workflow instance 38 may be a class that implements a method that accepts the flow component objects 38a-f, which may be configured simply as a few lines of code or configured elaborately as services. The flow component object 38a-f contains metadata including the component type, name, and configuration data, and the workflow engine 24 is configured to download the flow component objects 38a-f on demand to generate the workflow instance. The method returns an updated flow component object 38a-f, which is passed to the next component in the workflow instance 38. The method may also return a “next” value, which is the key of the next component 38b-f in the workflow instance 38. If the “next” value is an “exit” value, the workflow instance 38 is completed and the final context object 50 is outputted in the response 40. A given component 38a-f can update the context, the configuration data, and the “next” values as needed, thereby allowing for dynamic flow control from both within the component 38a-f and the entire workflow instance 38.

Components 38a-f in the workflow instance 38 are configured to hold an internal state from one execution to the next. The data for the internal state may be stored in the context 34 and/or separate persistent storage device 18. The data for the internal state may be stored in the context 34 when it is determined that the data for the internal state is needed for the duration of the workflow instance 38. When it is determined that the data for the internal state is needed for the duration of a session of multiple workflow instances, including the current workflow instance 38, then the data for the internal state may be stored in the persistent storage device 18.

Each component 38a-f in the workflow instance 38 is configured to make calls to the specialized agent services 72. These calls initiate the execution of specific tasks within the workflow instance 38. For instance, a component 38a-f may require data analysis, natural language processing, or image recognition capabilities. To fulfill these tasks, a component 38a-f may call upon an agent service 72 that possesses the requisite skills 84.

Agent services 72 may not only be skill-specific, but also be configured to generate prompts 82 to send to generative models 74. This feature enables a dynamic and responsive system where each agent service 72 can request information or processing from a generative model 74, so that at least one of the components 38a-f interfaces with a generative model 74. For example, an agent service 72 specializing in data analytics may generate a prompt 82 requesting a generative model 74 to analyze a complex set of data and return insights.

Each agent service 72 may be configured with its own set of skills 84 determining the type of executable tasks. For instance, one agent service 72 may be configured to process numerical data, while another may be configured to handle linguistic analysis.

Each agent service 72 may retrieve agent-specific resources 80, which may include tools, databases, or software that a particular agent service 72 can access. These resources 80 are tailored to the skills 84 of the agent service 72. For example, an agent service 72 focused on language translation may have access to extensive linguistic databases in the agent-specific resources 80.

Each agent service 72 may be equipped with agent-specific memory 78 which allows the agent 72 to store and recall information relevant to its tasks. For instance, an agent 72 specializing in user interactions may remember past user preferences to provide a more personalized experience.

In contrast to agent-specific memory 78, shared memory 76 is a common resource accessible by all agent services 72 within the workflow instance 38. This shared memory 76 facilitates the exchange and storage of information that is relevant across different agents 72, thereby ensuring coherence and continuity in the workflow instance 38, as agents can access and update shared data.

The workflow engine 24 executes a first set of components of the plurality of components 38a-f, including a first component 38a, to generate a first context. Based on the first context, the workflow engine 24 executes a second component 38c following the first set of components to generate a second context. The verification module 42 performs verification of the second context to generate a verification response, and determines whether the verification response is below or above a first predetermined threshold. In one example, a trained generative language model may be queried to query the confidence in the sufficiency of a candidate response. For example, the trained generative language model may be prompted to answer whether the candidate response answers sufficiently the present question to a high degree of confidence. Other threshold examples are described below.

The trained generative language model of the verification module 42 is a generative model that has been configured through machine learning to receive input that includes natural language text and generate output that includes natural language text in response to the input. It will be appreciated that the trained generative language model can be a large language model (LLM) having tens of millions to billions of parameters, non-limiting examples of which include GPT-3, BLOOM, and LLaMa-2. The trained generative language model can be a multi-modal generative model configured to receive multi-modal input including natural language text input as a first mode of input and image, video, or audio as a second mode of input, and generate output including natural language text based on the multi-modal input. The output of the multi-modal model may additionally include a second mode of output such as image, video, or audio output. Non-limiting examples of multi-modal generative models include Kosmos-2 and GPT-4 VISUAL. Further, the trained generative language model can be configured to have a generative pre-trained transformer architecture, examples of which are used in the GPT-3 and GPT-4 models.

A trained generative language model queried by the verification module 42 may be trained on a vast training corpus of text data, including various candidate responses that are assigned various confidence scores as ground truth, enabling the LLM to make predictions about the sufficiency of the candidate response. The candidate response may be initially processed in a tokenized form by breaking down the text of the candidate response into tokens. The LLM may receive these tokens as input, and generate a confidence score based on the tokens of the candidate response. The confidence score is subsequently returned to the verification module 42, which compares the returned confidence score, or verification response, to the first predetermined threshold, to determine whether the verification response is below or above the first predetermined threshold.

Responsive to determining that the verification response is below the first predetermined threshold, the workflow engine 24 executes the first set of components, including the first component 38a, again to regenerate the first context and the second context. Responsive to determining that the verification response is above the first predetermined threshold, the workflow engine 24 executes a remainder of the plurality of components 38a-f of the generated workflow instance based on the second context to generate a response 40 for the prompt 30. The generated response 40 for the prompt 30 is subsequently outputted on the GUI 26. Accordingly, the workflow engine 24 implements a rewinding mechanism so that, in instances where the sequence of components do not achieve the desired response, the workflow engine 24 may ‘rewind’ the context to a previous stage in the workflow instance 38.

It will be appreciated that one or a plurality of the components 38a-f may be configured to pass contexts to the verification module 42 for verification to generate verification responses. The designation of the one or the plurality of components 38a-f to pass contexts to the verification module 42 may be strategically determined based on predetermined criteria, which may include latency and other computational constraints. When computational constraints are not considered a significant factor, all of the components 38a-f of the workflow instance 38 may be designated to pass contexts to the verification module 42 for verification. Further, the verification module 42 may record and compile verification responses generated during the execution of the workflow instance 38 and output the verification responses as a verification log 48, which may be used to train the workflow engine 24 to generate workflow instances 38 that require fewer re-executions of components.

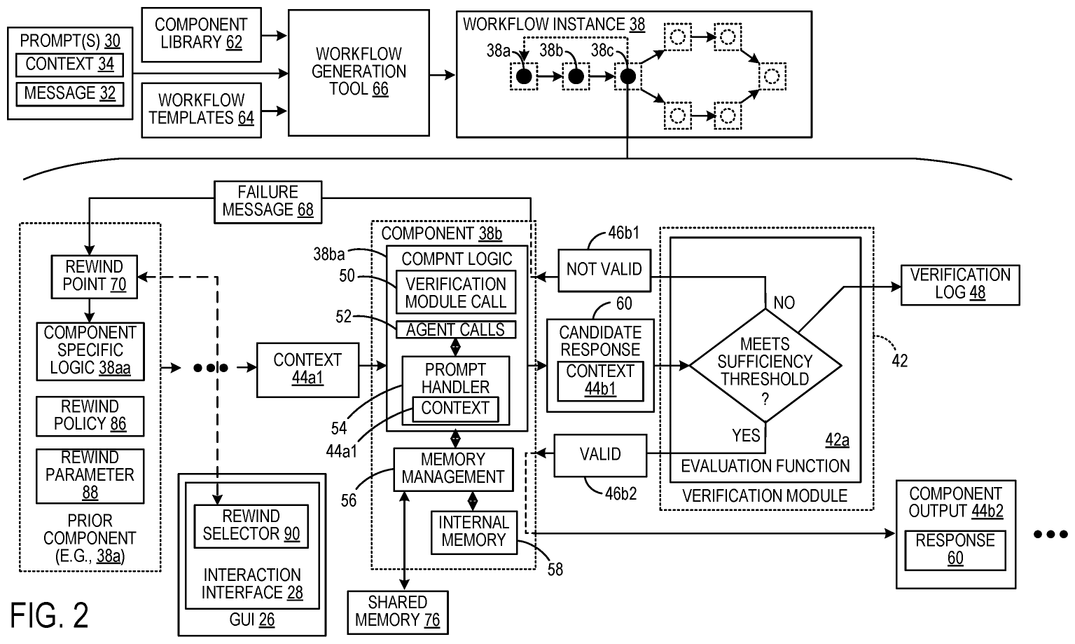

Turning to FIG. 2, the rewinding mechanism in the workflow instance 38 implemented by the workflow engine 24 of FIG. 1 is described in further detail. The workflow instance 38 may be determined or generated based on workflow templates 64 including tasks and workflows which execute various components that are defined in a component library 62. These components may include executable trained generative language models, including LLMs. Workflow templates 64 may represent various problem solving strategies to be implemented by the trained generative language models defined in the component library 62. A workflow generation tool 66 may determine or generate a recommended workflow instance 38 for a predicted task based on the context 34 and message 32 of the prompt 30, utilizing the workflow definitions provided in the workflow templates 64 and the components provided in the component library 62. It will be appreciated that the description of the aforementioned trained generative language model queried by the verification module 42 substantially applies to the trained generative language models defined in the component library 62.

For example, one of the components in the component library 62 may be an online order component which includes a specialized LLM configured to process online orders. This specialized LLM may be trained on training data including a variety of online orders from customers at restaurants, and configured to interpret complex, natural language order instructions from users, tokenizing these instructions and then generating actionable commands. Through integration with an Application Programming Interface (API), these actionable commands may then be channeled to various restaurant applications to complete online orders efficiently.

Following the pathway of the workflow instance 38 generated by the workflow generation tool 66, a prior component (38a, for example) executes component specific logic 38aa to generate output in the form of a context 44a1. A component 38b downstream of the prior component 38a receives the context 44a1 as input, and executes component logic 38ba to process the context 44a1. The component logic 38ba may include a prompt handler 54 configured to handle the context 44a1 by performing various actions to generate a candidate response 60 including a context 44b1. Responsive to receiving the context 44a1, the prompt handler 54 may perform agent calls 52 to interact with various agents which may interface with generative models. The prompt handler 54 may also perform memory management 56 to interact with both the internal memory 58 storing information relevant to the workflow instance 38, as well as shared memory 76 storing information relevant to all agents interacted with by the agent calls 52. These actions contribute to the generation of the candidate response 60 that is to be sent to the verification module 42.

The component logic 38ba performs a verification module call 50 by sending the generated candidate response 60 with the generated context 44b1 to the verification module 42 for verification. The evaluation function 42a of the verification module determines whether the generated candidate response 60 meets a predetermined sufficiency threshold. For example, the evaluation function 42a may determine whether the generated candidate response 60 is above or below a predetermined threshold. Responsive to determining that the candidate response 60 does not meet the sufficiency threshold, the verification module 42 generates and outputs a verification response 46b1 which indicates a ‘not valid’ or invalid context. Responsive to receiving the verification response 46b1 indicating an invalid context, the component logic 38ba sends a failure message 68 to a rewind point 70 in the prior component 38a, so that the prior component 38a is executed again to regenerate the context 44a1.

When the failure message 68 is received by the prior component 38a, the component specific logic 38aa may generate the context 44a1 using a different response strategy from the one initially used to generate the context 44a1. The different response strategy may be determined based on a rewind path adjustment policy 86 which selects the different response strategy based on a rewind parameter 88 which is set when the rewind point 70 is reached during the execution of the workflow instance 38. For example, the rewind parameter 88 may indicate how many times the rewind point 70 is reached during a single traversal of the workflow instance 38, and the different response strategy may be to call a different generative model from a component of the workflow instance 38 on each successive pass through the rewind point 70 until the verification module 42 outputs a verification response 46b2 indicating a ‘valid’ context. The different generative model may be a higher parameter generative model, for example. In one specific example, a first pass may call lower parameter, less computationally expensive, and lower latency generative model, and the rewind policy may specify that on each subsequent pass through the rewind path a higher parameter, higher computational cost, higher latency, but higher accuracy model be called, until a ‘valid’ context is reached, or a maximum number of passes is made through the rewind path. In this way, a quick but lower accuracy model may be tried initially, and if unsuccessful higher cost and higher accuracy models may be tried in subsequent passes.

In other examples, the different response strategy may involve using a different agent or using a different parallel processing pathway. The different parallel processing pathway may have components added or deleted from the workflow instance 38, for example. Accordingly, modifications to the response strategy increase the likelihood that the verification module 42 outputs a ‘valid’ verification response 46b2.

However, the use of a different generative model, agent, or parallel processing pathway may also incur an additional latency burden due to the higher computational cost of using a different response strategy. Accordingly, the reward policy 86 may impose a predetermined latency burden threshold, and exclude specific response strategies from being executed in the workflow instance 38 if the estimated additional latency burden exceeds the predetermined latency burden threshold. In one example, a rewind selector 90 may be displayed on an interaction interface 28 of a GUI 26, which enables the user to control the workflow instance 38 at the rewind point 70. By activating the rewind selector 90, the user may cause the workflow engine 24 to execute a different response strategy, as opposed to letting the workflow instance 38 automatically execute a different response strategy.

On the other hand, responsive to determining that the candidate response 60 meets the sufficiency threshold, the verification module 42 generates and outputs a verification response 46b2 which indicates a ‘valid’ context. Responsive to receiving the verification response 46b2 indicating a ‘valid’ context, the component logic 38ba of the component 38b proceeds to pass along the candidate response 60 as component output 44b2 to the next component in the remainder of the components of the generative workflow instance 38. The component output 44b2 may be generated in the form of another context. The verification responses 46b1, 46b2 may be outputted as a verification log 48 which is later used to train the workflow generation tool 66 to generate workflow instances 38 that require fewer re-executions of components.

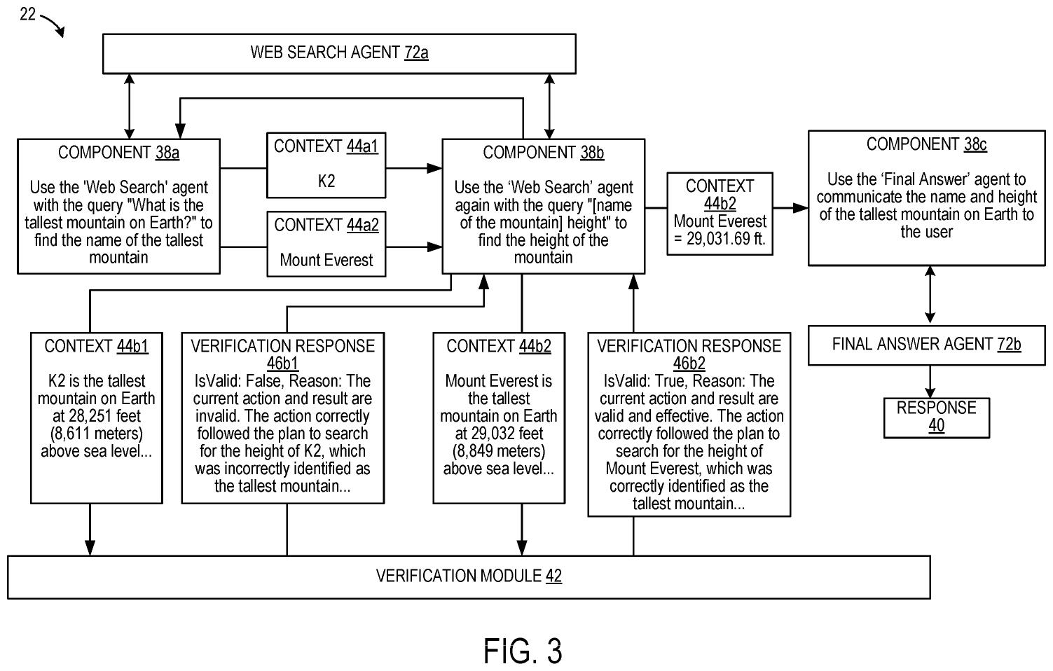

Turning to FIG. 3, a detailed example of the workflow instance 38 of FIG. 1 is described, in which a user inputs a prompt 30 asking what the tallest mountain on Earth is. The workflow engine 24 receives the prompt 30 and extracts the context 34, which is the query “What is the tallest mountain on Earth?” A workflow instance 38 is generated and executed based on the context 34. Then, a first set of components, including the trigger component 38a, is executed to generate a first context via a first response strategy.

In this example, the trigger component 38a uses the web search agent 72a with the query “What is the tallest mountain on Earth?” to find the name of the tallest mountain on Earth. The web search agent 72a uses a web browsing function to search the Internet for the answer to the user's query, and returns ‘K2’ as the answer to the query sent by the trigger component 38a. The answer ‘K2’ is incorporated into the generated first context 44a1 and sent to the second component 38b following the first set of components. Based on the first context 44a1, the workflow engine 24 executes the second component 38b, which uses the web search agent 72a again with the query “[name of the mountain] height” to find the height of the mountain”. The web search agent 72a returns ‘K2 is the tallest mountain on Earth at 28,251 feet (8,611 meters) above sea level . . . ’ as the answer to the query sent by the second component 38b. This answer is incorporated into the second context 44b1 and sent to the verification module 42.

The verification module 42 performs verification of the second context 44b1 and generates a verification response. The verification module 42 then determines whether the verification response is above or below a first predetermined threshold. In this example, the verification module 42 generates and outputs a verification response 46b1 which indicates a ‘false’ or invalid context. The verification response 46b1 includes an explanation that, while the action correctly followed the plan to search for the height of the mountain, K2 was incorrectly identified as the tallest mountain. The verification module 42 has determined that the verification response 46b1 is below the first predetermined threshold.

Responsive to determining that the verification response 46b1 is below the first predetermined threshold, the first set of components, including the trigger component 38a, is executed again to regenerate the first context and the second context. In this example, the workflow engine 24 restores the context to the previous stage in the workflow instance 38 and performs the query again at the trigger component 38a using a second response strategy that is different from the first response strategy that was initially used to generate the first context.

The second response strategy may involve generating the first context via a second generative model that is different from a first generative model that was used to generate the first context via the first response strategy. Alternatively, the second response strategy may involve generating the first context via a second agent that is different from a first agent that was used to generate the first context via the first response strategy. In another example, the second response strategy may involve generating the first context via a second parallel processing pathway that is different from a first parallel processing pathway that was used to generate the first context via the first response strategy.

When the trigger component 38a performs the query again, the web search agent 72a returns ‘Mount Everest’ as the answer to the query sent by the trigger component 38a. The answer ‘Mount Everest’ is incorporated into the generated first context 44a2 and sent to the second component 38b following the first set of components.

Based on the first context 44a2, the workflow engine 24 executes the second component 38b, which uses the web search agent 72a again with the query “[name of the mountain] height“to find the height of the mountain”. The web search agent 72a returns ‘Mount Everest is the tallest mountain on Earth at 29,032 feet (8,849 meters) above sea level . . . ’ as the answer to the query sent by the second component 38b. This answer is incorporated into the second context 44b2 and sent to the verification module 42.

This time, the verification module 42 generates and outputs a verification response 46b2 which indicates a ‘true’ or valid context. The verification response 46b2 includes an explanation that the action correctly followed the plan to search for the height of the mountain, Mount Everest, which was correctly identified as the tallest mountain. The verification module 42 has determined that the verification response 46b2 is above the first predetermined threshold.

Responsive to determining that the verification response 46b2 is above the first predetermined threshold, the workflow engine 24 proceeds to execute a remainder of the plurality of components 38a-c of the generative workflow instance 38 (third component 38c) based on the second context 44b2. The third component 38c may use the final answer agent 72b to communicate the name and height of the tallest mountain on Earth to the user as the response 40 to be displayed on an interaction interface 28 of the GUI 26.

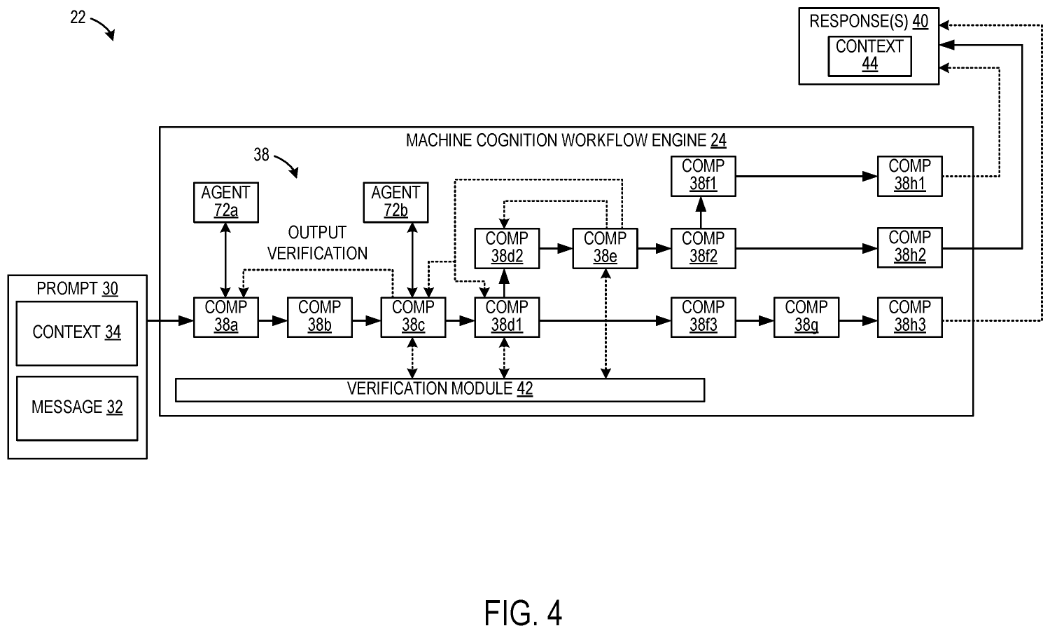

Turning to FIG. 4, a detailed view is illustrated of the processes performed by the machine cognition workflow engine 24 executing an exemplary workflow instance 38 with a plurality of components 38a-h3.

This workflow instance 38 has three parallel processing pathways. The workflow instance 38 initially proceeds linearly from the trigger component 38a through components 38b, 38c, and 38d1. At branching component 38d1, the workflow instance 38 may proceed along a first parallel processing pathway that executes components 38f3, 38g, and 38h3 to generate the final response 40, or a second parallel processing pathway that executes components 38d2, 38e, and 38f2. At branching component 38f2, the workflow instance 38 may proceed along a third parallel processing pathway that executes component 38h2, or a fourth parallel processing pathway that executes components 38f1 and 38h1 to generate the final response 40 including the final context object 50.

The components 38a-h3 of the workflow instance 38 interact with various agents 72 which may interface with generative models. In this example, the first component 38a interacts with a first agent 72a, and a second component 38b interacts with a second agent 72b. In some examples, each component 38a-h3 may interact with machine learning models, so that outputs of the plurality of components 38a-h3 are machine learning model outputs generated via multi-stage machine learning model chaining via the plurality of components 38a-h3.

In this example, the workflow engine 24 executes a first set of components, including a first component 38a and component 38b. The first component 38a receives the context 34 and generates a first context which is passed to component 38b, which generates the next context which is received by the second component 38c following the first set of components to generate a second context. The verification module 42 performs a verification of the second context to generate a verification response.

The verification module 42 performs verification of the second context to generate a verification response, and determines whether the verification response is below a first predetermined threshold. Responsive to determining that the verification response is below the first predetermined threshold, the workflow engine 24 execute the first set of components (components 38a, 38b) again to regenerate the first context and the second context. Responsive to determining that the verification response is above the first predetermined threshold, the workflow engine 24 executes a remainder 38d1-h3 of the plurality of components 38a-h3 of the generated workflow instance 38 based on the second context.

Turning to the components downstream of component 38c, branching component 38d1 initially uses a first response strategy to choose a first parallel processing pathway to pass its context to component 38d2, which in turn passes its context to component 38e. The context generated by component 38e is then verified by the verification module 42.

In one example where two predetermined thresholds are used to verify the context generated by component 38e, responsive to determining that the verification response is below a first predetermined threshold, the workflow engine 24 may execute component 38d2 again to cause component 38e to regenerate its context.

Responsive to determining that the verification response is below a second predetermined threshold that is below the first predetermined threshold, the context may be regenerated by executing the first set of components (component 38d2) and a second set of components (components 38c, 38d1) preceding the first set of components. Alternatively, the context may be regenerated by executing component 38d1 to choose the first parallel processing pathway to pass its context to component 38f3 instead of component 38d2, so that components 38f3, 38g, and 38h3 are executed to generate the final response 40.

In some examples, a predetermined time period may be imposed, so that when the verification of a context exceeds the predetermined time period, the verification response is randomly generated. In other examples, the time spent on generating the verification response may be limited based on a priority profile of the component generating the context. For example, it may not be desirable to wait too long at one stage in the workflow instance 38, especially when a user expects an expedited response for a time-sensitive query in an emergency situation. Therefore, the priority profiles of relatively important components may be elevated to ensure that the time spent on verification does not exceed a predetermined time period.

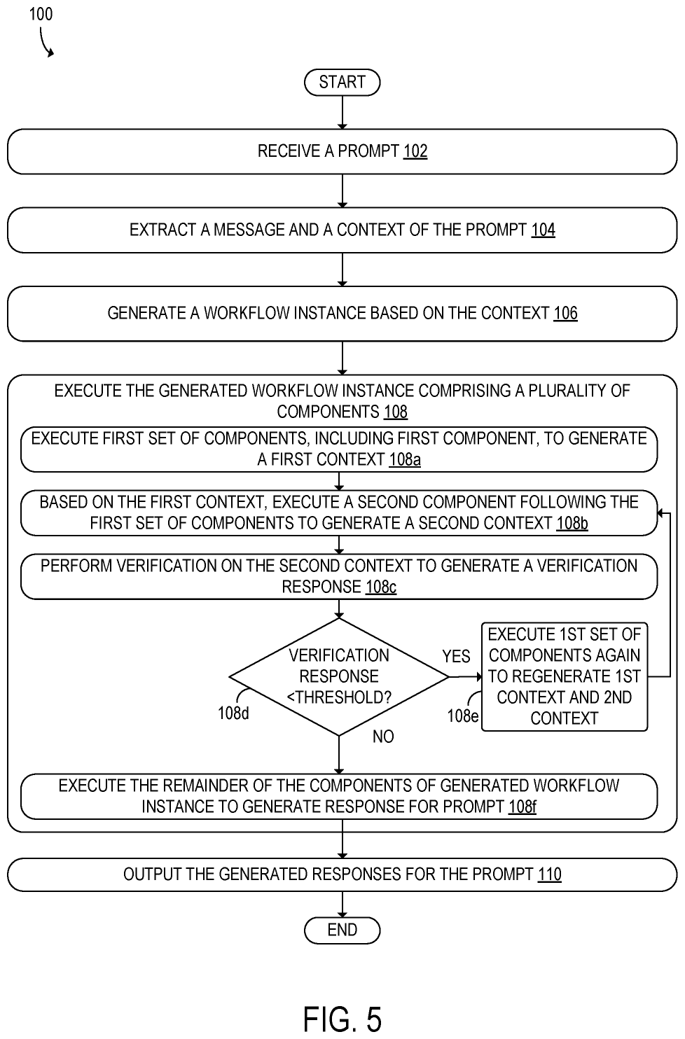

FIG. 5 is a flowchart that illustrates a first method 100 for managing workflows. The first method 100 may be implemented on the computing system 10 illustrated in FIG. 1 or 2 above, which include processing circuitry and associated memory configured to implement an interaction interface and a machine cognition workflow engine. Alternatively, other suitable computing hardware and software may be utilized.

At 102, the method includes receiving a prompt. At 104, the method includes extracting a message and a context of the prompt. At 106, the method includes generating a workflow instance based on the context. At 108, the method includes executing the generated workflow instance comprising a plurality of components.

At 108a, the method includes executing a first set of components of the plurality of components, including a first component, to generate a first context. At 108b, the method includes, based on the first context, executing a second component following the first set of components to generate a second context. At 108c, the method includes performing verification of the second context to generate a verification response.

At 108d, it is determined whether the verification response is below a first predetermined threshold. At 108e, responsive to determining that the verification response is below the first predetermined threshold, the method includes executing the first set of components again to regenerate the first context and the second context, and the method returns to 108b. At 108f, responsive to determining that the verification response is above the first predetermined threshold, the method includes executing a remainder of the plurality of components of the generated workflow instance based on the second context to generate a response for the prompt. At 110, the method includes outputting the generated response for the prompt.

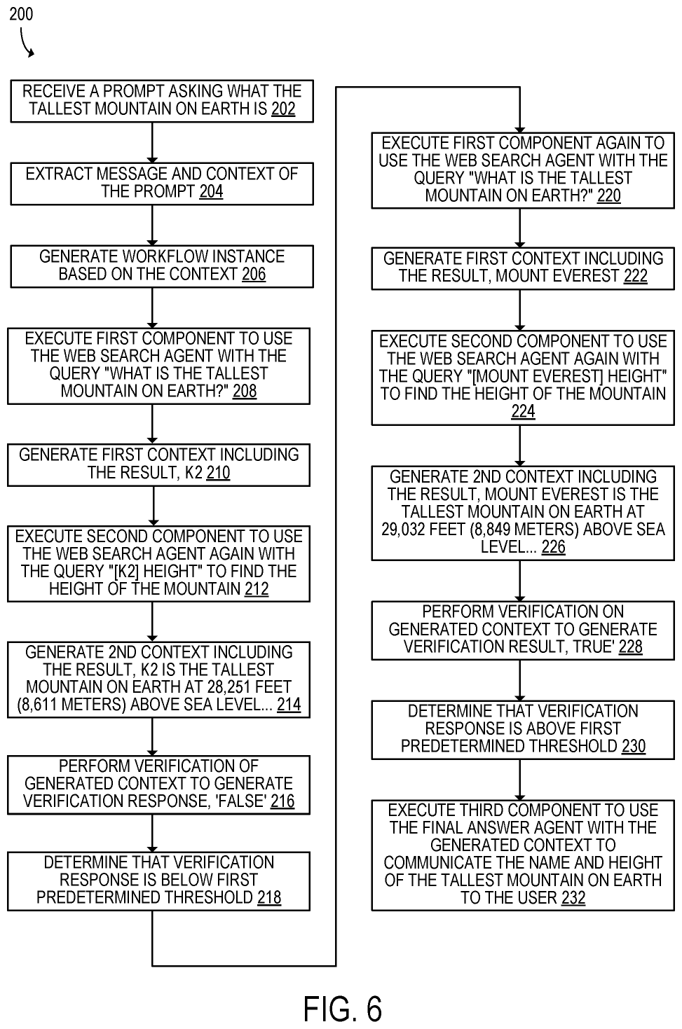

FIG. 6 is a flowchart that illustrates a second method 200 for managing workflows as described in FIG. 3. The second method 200 may be implemented on the computing system 10 illustrated in FIG. 3 above, which include processing circuitry and associated memory configured to implement an interaction interface and a machine cognition workflow engine. Alternatively, other suitable computing hardware and software may be utilized.

At 202, the method includes receiving a prompt 30 (for example, a prompt asking what the tallest mountain on Earth is). At 204, the method includes extracting a message and a context of the prompt. At 206, the method includes generating a workflow instance based on the context. At 208, the method includes executing a first component (for example, executing a first component to use the web search agent with the query “What is the tallest mountain on Earth?”). At 210, the method includes generating a first context (for example, generating a first context including the result to the query). At 212, the method includes executing the second component (for example, executing the second component again to use the web search agent again with the query, “[K2] height” to find the height of the mountain). At 214, the method includes generating the second context (for example, generating the second context including the query result, ‘K2 is the tallest mountain on Earth a) 28,251 feet (8,611 meters) above sea level . . . ’).

At 216, the method includes performing verification of the generated context to generate a verification response (for example, a verification response which indicates a ‘false’ or invalid context. At 218, the method includes determining that the verification response is below the first predetermined threshold.

At 220, responsive to determining that the verification response is below the first predetermined threshold, the method includes executing the first component again (for example, executing the first component again to use the web search agent with the query, “What is the tallest mountain on Earth?”). At 222, the method includes generating a first context (for example, generating a first context including the result to the query, ‘Mount Everest’). At 224, the method includes executing the second component (for example, executing the second component to use the web search agent again with the query, “[Mount Everest] height” to find the height of the mountain). At 226, the method includes generating the second context (for example, generating the second context including the query result, ‘Mount Everest is the tallest mountain on Earth at 29,032 feet (8,849 meters) above sea level . . . ’).

At 228, the method includes performing verification of the generated context to generate a verification response (for example, a verification response which indicates a ‘true’ or valid context). At 230, the method includes determining that the verification response is above the first predetermined threshold. At 232, the method includes executing a third component (for example, executing a third component to use the final answer agent with the generated context to communicate the name and height of the tallest mountain on earth to the user).

The above-described system and methods introduce non-deterministic, goal-driven predictive evaluation processes with a ‘rewinding’ mechanism to manage workflows in artificial intelligence (AI) systems, especially in the field of natural language processing and chatbot technology. In instances where executed steps in a workflow do not achieve a desired goal, the workflow can be rewound to a previous stage for re-evaluating the execution of a task in the workflow. This rewinding and re-evaluation process enables the system to iteratively approach the most efficient and accurate solution for executing a workflow, thereby enhancing the overall user experience in AI-driven interactions.

In generative model chaining flows, this approach allows for the dynamic evaluation of tasks within a model chain, where the sequence of steps is not strictly predetermined, but can adapt based on the evolving requirements of the workflow. Steps in the model chain can be executed differently based on predictions of earlier solutions, so that the generative model chain can be iteratively modified and refined through a dynamic verification process at various points along the generative model chain.

In some embodiments, the methods and processes described herein may be tied to a computing system of one or more computing devices. In particular, such methods and processes may be implemented as a computer-application program or service, an application-programming interface (API), a library, and/or other computer-program product.

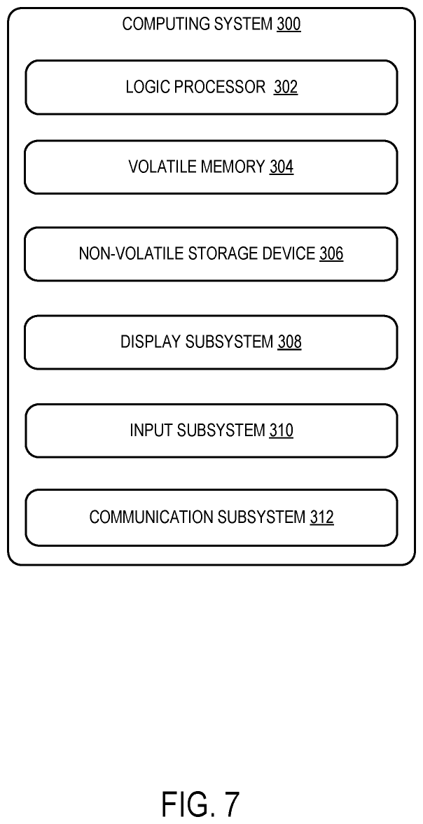

FIG. 7 schematically shows a non-limiting embodiment of a computing system 300 that can enact one or more of the methods and processes described above. Computing system 300 is shown in simplified form. Computing system 300 may embody the computing system 10 described above and illustrated in FIG. 1-3, respectively. Components of computing system 300 may be included in one or more personal computers, server computers, tablet computers, home-entertainment computers, network computing devices, video game devices, mobile computing devices, mobile communication devices (for example, smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 7.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included display subsystem 308 may be used to present a visual representation of data held by non-volatile storage device 306. The visual representation may take the form of a GUI. As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs provide additional support for the claims of the subject application. One aspect provides a computing system, comprising a machine cognition workflow engine with a rewinding mechanism, configured to receive a prompt, extract a message and a context of the prompt, generate a workflow instance based on the context, execute the generated workflow instance comprising a plurality of components, execute a first set of components of the plurality of components, including a first component, to generate a first context, based on the first context, execute a second component following the first set of components to generate a second context, perform verification of the second context to generate a verification response, determine whether the verification response is below a first predetermined threshold, responsive to determining that the verification response is below the first predetermined threshold, execute the first set of components again to regenerate the first context and the second context, responsive to determining that the verification response is above the first predetermined threshold, execute a remainder of the plurality of components of the generated workflow instance based on the second context to generate a response for the prompt, and output the generated response for the prompt. In this aspect, additionally or alternatively, the first component may be initially configured to generate the first context via a first response strategy, and when the first context is regenerated by the first component responsive to determining that the verification response is below the first predetermined threshold, the first context may be regenerated via a second response strategy. In this aspect, additionally or alternatively, the first context generated via the first response strategy may be generated via a first generative model, and the first context generated via the second response strategy may be generated via a second generative model. In this aspect, additionally or alternatively, the first context generated via the first response strategy may be generated via a first agent, and the first context generated via the second response strategy may be generated via a second agent. In this aspect, additionally or alternatively, the first context generated via the first response strategy may be generated via a first parallel processing pathway, and the first context generated via the second response strategy may be generated via a second parallel processing pathway. In this aspect, additionally or alternatively, outputs of the plurality of components may be machine learning model outputs generated via multi-stage machine learning model chaining via the plurality of components. In this aspect, additionally or alternatively, when the verification of the second context exceeds a predetermined time period, the verification response may be randomly generated. In this aspect, additionally or alternatively, the predetermined time period may be determined based on a priority profile of the second component. In this aspect, additionally or alternatively, the verification response may be recorded and outputted as a verification log. In this aspect, additionally or alternatively, responsive to determining that the verification response is below a second predetermined threshold that is below the first predetermined threshold, the first context may be regenerated by executing the first set of components and a second set of components preceding the first set of components.

Another aspect provides a computing method, comprising receiving a prompt, extracting a message and a context of the prompt, generating a workflow instance based on the context, executing the generated workflow instance comprising a plurality of components, executing a first set of components of the plurality of components, including a first component, to generate a first context, based on the first context, executing a second component following the first set of components to generate a second context, performing verification of the second context to generate a verification response, determining whether the verification response is below a first predetermined threshold, responsive to determining that the verification response is below the first predetermined threshold, executing the first set of components again to regenerate the first context and the second context, responsive to determining that the verification response is above the first predetermined threshold, executing a remainder of the plurality of components of the generated workflow instance based on the second context to generate a response for the prompt, and outputting the generated response for the prompt. In this aspect, additionally or alternatively, the first component may be initially configured to generate the first context via a first response strategy, and when the first context is regenerated by the first component responsive to determining that the verification response is below the first predetermined threshold, the first context may be regenerated via a second response strategy. In this aspect, additionally or alternatively, the first context generated via the first response strategy may be generated via a first generative model, and the first context generated via the second response strategy may be generated via a second generative model. In this aspect, additionally or alternatively, the first context generated via the first response strategy may be generated via a first agent, and the first context generated via the second response strategy may be generated via a second agent. In this aspect, additionally or alternatively, the first context generated via the first response strategy may be generated via a first parallel processing pathway, and the first context generated via the second response strategy may be generated via a second parallel processing pathway. In this aspect, additionally or alternatively, outputs of the plurality of components may be machine learning model outputs generated via multi-stage machine learning model chaining via the plurality of components. In this aspect, additionally or alternatively, when the verification of the second context exceeds a predetermined time period, the verification response may be randomly generated. In this aspect, additionally or alternatively, the predetermined time period may be determined based on a priority profile of the second component. In this aspect, additionally or alternatively, the verification response may be recorded and outputted as a verification log.

Another aspect provides a computing system, comprising processing circuitry, and a storage device storing a program executable by the processing circuitry to execute a workflow instance comprising a plurality of components, execute a first set of components of the plurality of components, including a first component, to generate a first context, based on the first context, execute a second component following the first set of components to generate a second context, perform verification of the second context to generate a verification response, determine whether the verification response is below a first predetermined threshold, responsive to determining that the verification response is below the first predetermined threshold, execute the first set of components again to regenerate the first context and the second context, generate a response based on the second context, and output the generated response.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a machine cognition workflow engine with a rewinding mechanism, configured to:
receive a prompt;
extract a message and a context of the prompt;
generate a workflow instance based on the context;
execute the generated workflow instance comprising a plurality of components;
execute a first set of components of the plurality of components, including a first component, to generate a first context;
based on the first context, execute a second component following the first set of components to generate a second context;
perform verification of the second context to generate a verification response;
determine whether the verification response is below a first predetermined threshold;
responsive to determining that the verification response is below the first predetermined threshold, execute the first set of components again to regenerate the first context and the second context;
responsive to determining that the verification response is above the first predetermined threshold, execute a remainder of the plurality of components of the generated workflow instance based on the second context to generate a response for the prompt; and
output the generated response for the prompt.

2. The computing system of claim 1, wherein
the first component is initially configured to generate the first context via a first response strategy; and
when the first context is regenerated by the first component responsive to determining that the verification response is below the first predetermined threshold, the first context is regenerated via a second response strategy.

3. The computing system of claim 2, wherein
the first context generated via the first response strategy is generated via a first generative model; and
the first context generated via the second response strategy is generated via a second generative model.

4. The computing system of claim 2, wherein
the first context generated via the first response strategy is generated via a first agent; and
the first context generated via the second response strategy is generated via a second agent.

5. The computing system of claim 2, wherein
the first context generated via the first response strategy is generated via a first parallel processing pathway; and
the first context generated via the second response strategy is generated via a second parallel processing pathway.

6. The computing system of claim 1, wherein outputs of the plurality of components are machine learning model outputs generated via multi-stage machine learning model chaining via the plurality of components.

7. The computing system of claim 1, wherein when the verification of the second context exceeds a predetermined time period, the verification response is randomly generated.

8. The computing system of claim 7, wherein the predetermined time period is determined based on a priority profile of the second component.

9. The computing system of claim 1, wherein the verification response is recorded and outputted as a verification log.

10. The computing system of claim 1, wherein responsive to determining that the verification response is below a second predetermined threshold that is below the first predetermined threshold, the first context is regenerated by executing the first set of components and a second set of components preceding the first set of components.

11. A computing method, comprising:
receiving a prompt;
extracting a message and a context of the prompt;
generating a workflow instance based on the context;
executing the generated workflow instance comprising a plurality of components;
executing a first set of components of the plurality of components, including a first component, to generate a first context;
based on the first context, executing a second component following the first set of components to generate a second context;
performing verification of the second context to generate a verification response;
determining whether the verification response is below a first predetermined threshold;
responsive to determining that the verification response is below the first predetermined threshold, executing the first set of components again to regenerate the first context and the second context;
responsive to determining that the verification response is above the first predetermined threshold, executing a remainder of the plurality of components of the generated workflow instance based on the second context to generate a response for the prompt; and
outputting the generated response for the prompt.

12. The computing method of claim 11, wherein
the first component is initially configured to generate the first context via a first response strategy; and
when the first context is regenerated by the first component responsive to determining that the verification response is below the first predetermined threshold, the first context is regenerated via a second response strategy.

13. The computing method of claim 12, wherein
the first context generated via the first response strategy is generated via a first generative model; and
the first context generated via the second response strategy is generated via a second generative model.

14. The computing method of claim 12, wherein
the first context generated via the first response strategy is generated via a first agent; and
the first context generated via the second response strategy is generated via a second agent.

15. The computing method of claim 12, wherein
the first context generated via the first response strategy is generated via a first parallel processing pathway; and
the first context generated via the second response strategy is generated via a second parallel processing pathway.

16. The computing method of claim 11, wherein outputs of the plurality of components are machine learning model outputs generated via multi-stage machine learning model chaining via the plurality of components.

17. The computing method of claim 11, wherein when the verification of the second context exceeds a predetermined time period, the verification response is randomly generated.

18. The computing method of claim 17, wherein the predetermined time period is determined based on a priority profile of the second component.

19. The computing method of claim 11, wherein the verification response is recorded and outputted as a verification log.

20. A computing system, comprising:
processing circuitry; and
a storage device storing a program executable by the processing circuitry to:
execute a workflow instance comprising a plurality of components;
execute a first set of components of the plurality of components, including a first component, to generate a first context;
based on the first context, execute a second component following the first set of components to generate a second context;
perform verification of the second context to generate a verification response;
determine whether the verification response is below a first predetermined threshold;
responsive to determining that the verification response is below the first predetermined threshold, execute the first set of components again to regenerate the first context and the second context;
generate a response based on the second context; and
output the generated response.
